(19) United States
(12) Patent Application Publication
(10) Pub. No.: US 2025/0113778 A1
(43) Pub. Date: Apr. 10, 2025

(54) GRAFTING ANIMAL REPELLENCY

(71) Applicant: Matthew Ryan Bornstein, Muttontown, NY (US)

(72) Inventor: Matthew Ryan Bornstein, Muttontown, NY (US)

(21) Appl. No.: 18/907,043

(22) Filed: Oct. 4, 2024

Related U.S. Application Data
(60) Provisional application No. 63/588,387, filed on Oct. 6, 2023.

(51) Int. Cl. A01G 2/35; A01G 13/00

(52) U.S. Cl. CPC A01G 2/35; A01G 13/00

(57) ABSTRACT

Grafted plant bodies and methods of conferring animal repellency to plants via grafting are described herein. Generally, a plant having animal repellent properties is grafted onto a plant without animal repellent properties.

### CROSS-REFERENCE TO RELATED APPLICATIONS

This application claims priority to U.S. Patent Application No. 63/588,387, filed Oct. 6, 2023, which is herein incorporated by reference in its entirety.

### FIELD OF DISCLOSURE

The present disclosure is related to forming plant grafts with animal (e.g., deer, mosquito, nematode) repellency. Generally, grafted plant bodies having animal repellent properties are formed by grafting animal repellent portions of plants onto another plant.

### BACKGROUND

Human life often involves unwanted interactions with animals. Even in urban and suburban settings, animal inhabitants of the area often cause stress and problems for human inhabitants. For example, deer often eat the plants groomed by humans for their homes. A variety of solutions exist to prevent or deter this ingestion such as spraying the plants with materials that repel deer or the construction of barriers that prevent deer from accessing the plants. However, these solutions are often insufficient, require significant upkeep, or degrade aesthetics associated with the plants themselves.

It is therefore an object of the invention to provide solutions to repel animals from plants.

### SUMMARY

I have invented a unique way of keeping deer away from plants susceptible to being eaten by animals such as deer. This disclosure involves grafting different plants to combine plants having natural animal repellent properties with plants that do not have these properties. In particular, the present disclosure includes combining plants that are deer resistant to plants that are more likely to get eaten by deer. By doing so, deer will be less likely to eat a plant they would otherwise consume because it includes portions, such as branches, which are deer resistant. By leveraging the natural repellency of certain plants and the plant grafting technique, nearly all plants may be made animal repellent (or have increased animal repellency as opposed to the corresponding ungrafted species or cultivar).

Grafting is the horticultural practice of fusing two plants so that they grow as one. Nearly all perennial orchard crops and ornamentals (i.e. apple, cherry, pecan, grape, rose, olive, citrus, maple, etc.) as well as many high-value annual crop species are grafted commercially.

Grafting can serve to improve certain characteristics, including disease resistance and the ability to adapt to extreme temperatures or to edaphic factors, such as salt tolerance. In many cases, a disease resistant rootstock is able to confer protection against soil borne pathogens when grafted to a susceptible scion.

Grafting also enables one plant to be supported by multiple root systems or one root system to support multiple plants as branches. This can speed the growth of an individual scion or allow the propagation of multiple scions to conserve space.

The present disclosure provides a grafted plant body between a rootstalk and a scion, wherein the rootstalk or scion comprises a flower, fruit, or vegetable from a first plant species or cultivar, and the other of the rootstalk or scion comprises an animal (e.g., deer, nematode, insect such as mosquito) resistant portion of a second plant species or cultivar. In some embodiments, the animal resistant portion is a deer resistant portion. In various aspects, the rootstalk is directly grafted to the scion. In various implementations, the rootstalk is grafted to the scion via one or more graft mediums. In certain aspects, the scion comprises an animal resistant portion of a plant species or cultivar.

Generally, the grafted plant body is grafted by attaching a plant portion having the animal repellent characteristics. These characteristics may include, for example, smell, taste, color, and/or toxicity which induces the animal repellency. In some embodiments, the animal resistant portion of the second plant species or cultivar is the flowers or foliage of the second plant species or cultivar. For example, the second plant species or cultivar is Zinnia (e.g. the plant species or cultivar is from the genus Zinnia), rosemary (e.g., the plant species or cultivar is Salvia rosmarinus), marigold (e.g., the plant species or cultivar is from the genus Tagetes such as Tagetes patula, Tagetes lucida, or Tagetes minuta), fountain grass (e.g., the plant species or cultivar is from the genus Pennisettum including Pennisetum typhoideum, Pennisetum villosum, Penisettum candestinum, Pennisettum advena, Pennisettum alopecuroides, Pennisettum orentale, or Pennisetum setaceum) spider flower (e.g., the plant species or cultivar is from the genus Cleome such as Cleome hassleriana, the plant species is from the genus Grevillea such as Grevillea albiflora, Grevillea buxifolia, Grevillea mucronulata, Grevillea oleoides, Grevillea sericea, Grevillea speciosa), carolina jessamine (e.g., the plant species or cultivar is Gelsemium sempevirens), Wisteria (e.g., the plant species or cultivar is from the genus Wisteria such as Wisteria sinensis or Wisteria floribunda), Verbena (e.g., the plant species or cultivar is from the genus Verbena such as Verbena bonariensis, Verbena officinalis), bee balm (e.g., the plant species or cultivar is from the genus Monarda such as Monarda didyma or Monarda panorama), daffodil (e.g., the plant species or cultivar is from the genus Narcissus such as Narcissus poeticus), lavender (e.g., the plant species or cultivar is from the genus Lavandula such as Lavandula spica), wax Begonia (the plant cultivar is Begonia x semperflorens-cultorum), lamb's ear (the plant species or cultivar is Stachys byzantine (syn. lanata or olympica)), Vinca (the plant is from the genus Vinca such as Vinca difformis), star jasmine (the plant species or cultivar is Trachelospermum jasminoides), Allium (the plant species or cultivar is from the genus Allium such as Allium sativum, Allium flavum, Allium carinatum, Allium schoenoprasum, or Allium oreophilum), foxglove (e.g., the plant species or cultivar is from the genus Digitalis such as Digitalis purpurea, Digitalis ferruginea, Digitalis grandiflora, Digitalis lutea, Digitalis parviflora), Coleus (e.g., the plant species or cultivar or cultivar is from the genus Coleus such as Coleus amboinicus or Coleus scutellariodes), purple heart (e.g., the plant species or cultivar is Tradescantia pallida), butterfly bush/weed (e.g., the plant species or cultivar is Asclepias tuberosa), Coreopsis (e.g., the plant species or cultivar is from the genus Coreopsis such as Coreopsis gigantea), Cosmos (the plant species or cultivar is from the genus Cosmos such as Cosmos bipinnatus, or Cosmos sulphureus), autumn fern (e.g., the plant species or cultivar is Dryopteris erythrosora), coneflower (e.g., the plant species or cultivar is from the genus Dracopis, Echinacea, Rudbeckia, Ratibida, or Isopogon), flossflower (e.g., the plant species or cultivar is \Ageratum houstonianum), signet marigold (e.g., the plant species or cultivar is Tagetes tenuifolia), snapdragon (e.g., the plant species or cultivar is from the genus Antirrhinum such as Antirrhinum majus or Antirrhinum mole), boxwood (e.g., the plant species or cultivar is from the genus Buxus such as Buxus sempervirens or Buxus sinica), cinquefoil (e.g., the plant species or cultivar is from the genus Potentilla such as Potentilla reptans), butterfly bush (e.g., the plant species or cultivar is from the genus Buddleja such as Buddleja davidii or Buddleja globose or from the genus Rotheca such as Rotheca myricoides), spirea (e.g., the plant species or cultivar is from the genus Spiraea such as Spiraea salicifolia), juniper (e.g., the plant species or cultivar is from the genus Juniperus such as Junperus osteosperma or Juniperus communis, russian sage (e.g., the plant species or cultivar is Salvia yangii), fringed bleeding heart (e.g., the plant species or cultivar is Dicentra eximia), monkshood (e.g., the plant species or cultivar is from the genus Acontium such as Aconitum variegatum), peony (e.g., the plant species or cultivar is from the genus Paeonia such as Paeonia suffruticosa or Paeonia officinalis), black cohosh (e.g., the plant species or cultivar is Actaea racemosa), dusty miller (e.g., the plant species or cultivar is Centaurea cineraria), lamb's ear (e.g., the plant species or cultivar is Stachys byzantina), Japanese Pachysandra (e.g., the plant species or cultivar is Pachysandra terminalis), Japanese painted fern (e.g., Athyrium niponicum), lady's mantle (e.g., the plant species or cultivar is from the genus Alchemilla such as Alchemilla mollis), lily of the valley (e.g., the plant species or cultivar is Convallaria majalis), or Japanese sedge (e.g., the plant species or cultivar is Carex morrowii).

Various permutations of animal repellent characteristics with other plants are afforded by the present disclosure. For example, the first plant species or cultivar and/or the second plant species or cultivar may be selected from lavender (e.g., the plant species or cultivar is from the genus Lavandula such as Lavandula spica), dusty miller (e.g., the plant species or cultivar is Centaurea cineraria), Agastache (e.g., the plant species or cultivar is from the genus Agastache such as Agastache cusickii, Agastache foeniculum, Agastache (Pursh) Kuntze, Agastache nepetoides, Agastache occidentalis, Agastache parvifolia, Agastache rugosa, Agastache scrophulariifolia, or Agastache urticifola), Hydrangea (e.g., the plant species or cultivar is from the genus Hydrangea such as Hydrangea macrophylla, Hydrangea anomala, Hydrangea arborescens, Hydrangea aspera, Hydrangea bretschneideri, Hydrangea chinensis, Hydrangea chungii, Hydrangea cinerea, Hydrangea coenobialis, Hydrangea davidii, Hydrangea glaucescens, Hydrangea gracilis, Hydrangea heteromalla, Hydrangea hirta, Hydrangea hydrangeoides, Hydrangea hypoclauca, Hydrangea integrifolia, Hydrangea involucrata, Hydrangea jelskii, Hydrangea kwangsiensis, Hydrangea kwangtungensis, Hydrangea longifolia, Hydrangea longipes, Hydrangea macrocarpa, Hydrangea macrophylla, Hydrangea mangshanensis, Hydrangea paniculata, Hydrangea peruviana, Hydrangea petiolaris, Hydrangea quercifolia, Hydrangea radiata, Hydrangea robusta, Hydrangea sargentiana, Hydrangea scandens, Hydrangea serrata, Hydrangea serratifolia, Hydrangea strigosa, Hydrangea stylosa, Hydrangea tarapotensis, Hydrangea xanthoneura, or Hydrangea zhewanensis), Sage (e.g., a plant or cultivar from the Salvia such as Salvia officinalis or the genus Leucophyllum or the genus Artemisia), rosemary (e.g., the plant species or cultivar is Salvia rosmarinus), rose (e.g., a genus or cultivar from the genus Rosa such as Rosa rubiginosa, Rosa ‘precious platinum’, Rosa hemisphaerica, a plant or cultivar from the subgenus Hulthemia, Hesperrhodos, Platyrhodon, or Rosa including Banksianae, Bracteatae, Caninae, Carolinae, Chinesis, Gallicanae, Gymnocarpae, Laevigatae, Pimpinellifoliae Cinnamomeae, or Synstylae), butterfly bush (e.g., the plant species or cultivar is Asclepias tuberosa), Angelonia (e.g., a plant species or cultivar from the genus Angelonia), tomato plant (e.g., a species or cultivar of of Solanum lycopersicum), peppers (e.g., a species or cultivar from the Piperaceae family, a species or cultivar from the Capsicum genus), apple (e.g., a species or cultivar from Malus domestica), or Dahlia (e.g., a species or cultivar from the genus Dahlia such as Dahlia pinnata). In some embodiments, the first plant species or cultivar and the second plant species or cultivar are the same plant species. In some embodiments, the first plant species or cultivar and second plant species or cultivar are different species. In certain aspects, the first plant species or cultivar and second plant species or cultivar are different species from the same genus. In various embodiments, the first plant species or cultivar and second plant species or cultivar are different species from the same family.

Methods of forming a grafted plant body are also provided comprising joining the tissue from a first plant species or cultivar with a second plant species or cultivar, wherein the second plant species or cultivar comprises animal repellent properties and the grafted plant body comprises a flower or fruit from the first plant species or cultivar. For example, the method may comprise:
a) exposing the tissue of the first plant species or cultivar (e.g., via cutting);
b) exposing the tissue of the second plant species or cultivar (e.g., via cutting);
c) contacting the exposed tissues from the first and second plant species or cultivars for a time period and under conditions sufficient to join the tissue.
   In certain aspects, the method may comprise:
a) exposing the tissue of the first plant species or cultivar (e.g., via cutting);
b) exposing the tissue of the second plant species or cultivar (e.g., via cutting);
c) contacting the exposed tissues from the first plant species or cultivar to a graft medium; and
d) contacting the exposed tissues from the second plant species or cultivar to the graft medium;
   wherein steps c) and d) occur for a time period and under conditions sufficient to join the tissue.

In various implementations, the first plant species or cultivar is rootstalk. In some embodiments, the first plant species or cultivar is a scion. In some embodiments, the second plant species or cultivar is rootstalk. In certain aspects, the second plant species or cultivar is a scion.

### DETAILED DESCRIPTION

Detailed embodiments of the present disclosure are disclosed herein; however, it is to be understood that the disclosed embodiments are merely illustrative of the disclosure that may be embodied in various forms. In addition, each of the examples given in connection with the various embodiments of the disclosure is intended to be illustrative, and not restrictive.

All terms used herein are intended to have their ordinary meaning in the art unless otherwise provided. All concentrations are in terms of percentage by weight of the specified component relative to the entire weight of the topical composition, unless otherwise defined.

As used herein, “a” or “an” shall mean one or more. As used herein when used in conjunction with the word “comprising,” the words “a” or “an” mean one or more than one. As used herein “another” means at least a second or more.

As used herein, all ranges of numeric values include the endpoints and all possible values disclosed between the disclosed values. The exact values of all half integral numeric values are also contemplated as specifically disclosed and as limits for all subsets of the disclosed range. For example, a range of from 0.1% to 3% specifically discloses a percentage of 0.1%, 1%, 1.5%, 2.0%, 2.5%, and 3%. Additionally, a range of 0.1 to 3% includes subsets of the original range including from 0.5% to 2.5%, from 1% to 3%, from 0.1% to 2.5%, etc. It will be understood that the sum of all weight % of individual components will not exceed 100%.

By “consist essentially” it is meant that the ingredients include only the listed components along with the normal impurities present in commercial materials and with any other additives present at levels which do not affect the operation of the embodiments disclosed herein, for instance at levels less than 5% by weight or less than 1% or even 0.5% by weight.

The present disclosure relates to leveraging plant grafting to impart animal (e.g., deer) repellent properties onto plants and/or trees having portions previously susceptible to predation by animals (e.g., deer).

Grafting typically involves manually cutting the stems of a first plant and of a second plant. Typically, in grafting, after cutting, the severed stem of the first plant with the roots thereof attached to the stem, but the leaves removed, is placed against the severed stem of the second plant with the leaves thereof attached to the stem, but the roots removed. Subsequently, a clip is manually applied at and more in particular on or over the interface of the severed stems to keep the severed stems together and allow the grafting to take place, wherein the stems literally grow attached to one another. Grafting typically affords the ability to create a more substantive root system for leaves, fruits, and flowers which have less hearty root systems.

The present disclosure provides a grafted plant body between a rootstalk and a scion, wherein the rootstalk or scion comprises a flower, fruit, or vegetable from a first plant species or cultivar, and the other of the rootstalk or scion comprises an animal (e.g., deer, nematode, insect such as mosquito) resistant portion of a second plant species or cultivar. In some embodiments, the animal resistant portion is a deer resistant portion. In various aspects, the rootstalk is directly grafted to the scion. In various implementations, the rootstalk is grafted to the scion via one or more graft mediums. In certain aspects, the scion comprises an animal resistant portion of a second plant species or cultivar.

Grafting may occur via a graft system to allow for the joining of the tissues from the two plant species or cultivar. The graft system may include individual holders for the rootstalk and/or scion such that the scion may be joined with the rootstalk. The graft system may exhibit features that at least one of a first holder and a second holder comprising a stem compressing clamp. Preferably a size of the stem compressing clamp is uniform for grafting any particular combination of first and second plants. This may obviate a need to select which stems of first and second plants are, based on the respective sizes and in particular stem diameters thereof, best suited to be grafted.

In a potential additional or alternative embodiment, a graft system according to the present disclosure may be manufactured at least partially from bio-degradable material. This allows the graft system to be degraded without waste, but reusable systems may also prove feasible within the scope of protection for the present disclosure, but care should always be taken to avoid passing on of contaminations when deploying a re-usable system. Moreover, when an embodiment is based on cutting a holder loose from any support, post, carrier, or the like, the components may be made of a bio-degradable material.

The grafting of the present disclosure may occur between or within species. These grafts can be performed in several monocotyledon families which are phylogenetically separated by many millions of years (Katayama, Hironori, and Yasunari Ogihara. Current Genetics 29 (1996): 572-581; Soltis, D, et al. Phylogeny and Evolution of the Angiosperms. University of Chicago Press, 2018; Trias-Blasi, Anna, et al. Taxon 64.3 (2015): 552-581, which are hereby incorporated by reference in their entirety and particularly in relation to plant species), and not restricted to specific families.

The graft may occur as a young seedling (of either the scion or the rootstalk).

In some embodiments, one of the species may be a dicotyledon, commonly referred to as a dicot: These flowering plants typically contain two embryonic leaves in the seed, reticulate veins, and a taproot root system. Examples of dicots include many agronomic and horticultural plants, such as tomato, carrot, apple, oak, and soybean.

In some embodiments, one of the species may be a monocotyledon, commonly referred to as Monocot: These flowering plants typically contains one embryonic leaf in the seed, parallel veins, and a fibrous root system. Examples of monocots include many agronomic crops and ornamental plants, such as all cereals (i.e., maize, wheat, rice), banana, palm, orchids, lilies, and tulips.

Two plants are chosen for grafting. Any two plants that are closely related can be used, one of which has animal repellent properties. Grafting may be carried out between plants of the same genus, but can be performed between plants of different species (e.g., plants of the same family or order). In some embodiments, grafting can be carried out between plants of different species but of the same genus. Grafting can also be carried out between plants of different species but of the same family. Grafting can further be carried out between plants of different species but of the same order. Grafting can be carried out between plants of the same species but of a different genotype. Grafting can also be carried out between plants of the same species but of a different accession. Grafting can further be carried out between plants of the same species but of a different cultivar. Grafting can yet further be carried out between plants of the same species but of a different variety. In some embodiments, grafting may be carried out between plants of the same species. In some embodiments, grafting occurs between two species in the genus Hydrangea. In some embodiments, grafting occurs between the same species of plant in the genus Hydrangea. Typically, the grafting involves the addition of an animal-repellent portion of a first plant to a non-deer repellent second plant (even if the first and second plant are from the species).

Generally, the grafted plant body is grafted by attaching a plant portion having the animal repellent characteristics. These characteristics may include, for example, smell, taste, color, and/or toxicity which induces the repellency. In some embodiments, the animal resistant portion of the second plant species or cultivar is the flowers or foliage of the second plant species or cultivar. For example, the second plant species or cultivar is Zinnia (e.g. the plant species or cultivar is from the genus Zinnia), rosemary (e.g., the plant species or cultivar is Salvia rosmarinus), marigold (e.g., the plant species or cultivar is from the genus Tagetes such as Tagetes patula, Tagetes lucida, or Tagetes minuta), fountain grass (e.g., the plant species or cultivar is from the genus Pennisettum including Pennisetum typhoideum, Pennisetum villosum, Penisettum candestinum, Pennisettum advena, Pennisettum alopecuroides, Pennisettum orentale, or Pennisetum setaceum) spider flower (e.g., the plant species or cultivar is from the genus Cleome such as Cleome hassleriana, the plant species is from the genus Grevillea such as Grevillea albiflora, Grevillea buxifolia, Grevillea mucronulata, Grevillea oleoides, Grevillea sericea, Grevillea speciosa), carolina jessamine (e.g., the plant species or cultivar is Gelsemium sempevirens), Wisteria (e.g., the plant species or cultivar is from the genus Wisteria such as Wisteria sinensis or Wisteria floribunda), Verbena (e.g., the plant species or cultivar is from the genus Verbena such as Verbena bonariensis, Verbena officinalis), bee balm (e.g., the plant species or cultivar is from the genus Monarda such as Monarda didyma or Monarda panorama), daffodil (e.g., the plant species or cultivar is from the genus Narcissus such as Narcissus poeticus), lavender (e.g., the plant species or cultivar is from the genus Lavandula such as Lavandula spica), wax Begonia (the plant cultivar is Begonia x semperflorens-cultorum), lamb's ear (the plant species or cultivar is Stachys byzantine (syn. lanata or olympica)), Vinca (the plant is from the genus Vinca such as Vinca difformis), star jasmine (the plant species or cultivar is Trachelospermum jasminoides), Allium (the plant species or cultivar is from the genus Allium such as Allium sativum, Allium flavum, Allium carinatum, Allium schoenoprasum, or Allium oreophilum), foxglove (e.g., the plant species or cultivar is from the genus Digitalis such as Digitalis purpurea, Digitalis ferruginea, Digitalis grandiflora, Digitalis lutea, Digitalis parviflora), Coleus (e.g., the plant species or cultivar or cultivar is from the genus Coleus such as Coleus amboinicus or Coleus scutellariodes), purple heart (e.g., the plant species or cultivar is Tradescantia pallida), butterfly bush/weed (e.g., the plant species or cultivar is Asclepias tuberosa), Coreopsis (e.g., the plant species or cultivar is from the genus Coreopsis such as Coreopsis gigantea), Cosmos (the plant species or cultivar is from the genus Cosmos such as Cosmos bipinnatus, or Cosmos sulphureus), autumn fern (e.g., the plant species or cultivar is Dryopteris erythrosora), coneflower (e.g., the plant species or cultivar is from the genus Dracopis, Echinacea, Rudbeckia, Ratibida, or Isopogon), flossflower (e.g., the plant species or cultivar is \Ageratum houstonianum), signet marigold (e.g., the plant species or cultivar is Tagetes tenuifolia), snapdragon (e.g., the plant species or cultivar is from the genus Antirrhinum such as Antirrhinum majus or Antirrhinum mole), boxwood (e.g., the plant species or cultivar is from the genus Buxus such as Buxus sempervirens or Buxus sinica), cinquefoil (e.g., the plant species or cultivar is from the genus Potentilla such as Potentilla reptans), butterfly bush (e.g., the plant species or cultivar is from the genus Buddleja such as Buddleja davidii or Buddleja globose or from the genus Rotheca such as Rotheca myricoides), spirea (e.g., the plant species or cultivar is from the genus Spiraea such as Spiraea salicifolia), juniper (e.g., the plant species or cultivar is from the genus Juniperus such as Junperus osteosperma or Juniperus communis, russian sage (e.g., the plant species or cultivar is Salvia yangii), fringed bleeding heart (e.g., the plant species or cultivar is Dicentra eximia), monkshood (e.g., the plant species or cultivar is from the genus Acontium such as Aconitum variegatum), peony (e.g., the plant species or cultivar is from the genus Paeonia such as Paeonia suffruticosa or Paeonia officinalis), black cohosh (e.g., the plant species or cultivar is Actaea racemosa), dusty miller (e.g., the plant species or cultivar is Centaurea cineraria), lamb's ear (e.g., the plant species or cultivar is Stachys byzantina), Japanese Pachysandra (e.g., the plant species or cultivar is Pachysandra terminalis), Japanese painted fern (e.g., Athyrium niponicum), lady's mantle (e.g., the plant species or cultivar is from the genus Alchemilla such as Alchemilla mollis), lily of the valley (e.g., the plant species or cultivar is Convallaria majalis), or Japanese sedge (e.g., the plant species or cultivar is Carex morrowii).

Various permutations of animal repellent characteristics with other plants are afforded by the present disclosure. For example, the first plant species or cultivar and/or the second plant species or cultivar may be selected from lavender lavender (e.g., the plant species or cultivar is from the genus Lavandula such as Lavandula spica), dusty miller (e.g., the plant species or cultivar is Centaurea cineraria), Agastache (e.g., the plant species or cultivar is from the genus Agastache such as Agastache cusickii, Agastache foeniculum, Agastache (Pursh) Kuntze, Agastache nepetoides, Agastache occidentalis, Agastache parvifolia, Agastache rugosa, Agastache scrophulariifolia, or Agastache urticifola), Hydrangea (e.g., the plant species or cultivar is from the genus Hydrangea such as Hydrangea macrophylla, Hydrangea anomala, Hydrangea arborescens, Hydrangea aspera, Hydrangea bretschneideri, Hydrangea chinensis, Hydrangea chungii, Hydrangea cinerea, Hydrangea coenobialis, Hydrangea davidii, Hydrangea glaucescens, Hydrangea gracilis, Hydrangea heteromalla, Hydrangea hirta, Hydrangea hydrangeoides, Hydrangea hypoclauca, Hydrangea integrifolia, Hydrangea involucrata, Hydrangea jelskii, Hydrangea kwangsiensis, Hydrangea kwangtungensis, Hydrangea longifolia, Hydrangea longipes, Hydrangea macrocarpa, Hydrangea macrophylla, Hydrangea mangshanensis, Hydrangea paniculata, Hydrangea peruviana, Hydrangea petiolaris, Hydrangea quercifolia, Hydrangea radiata, Hydrangea robusta, Hydrangea sargentiana, Hydrangea scandens, Hydrangea serrata, Hydrangea serratifolia, Hydrangea strigosa, Hydrangea stylosa, Hydrangea tarapotensis, Hydrangea xanthoneura, or Hydrangea zhewanensis), Sage (e.g., a plant or cultivar from the Salvia such as Salvia officinalis or the genus Leucophyllum or the genus Artemisia), rosemary (e.g., the plant species or cultivar is Salvia rosmarinus), rose (e.g., a genus or cultivar from the genus Rosa such as Rosa rubiginosa, Rosa ‘precious platinum’, Rosa hemisphaerica, a plant or cultivar from the subgenus Hulthemia, Hesperrhodos, Platyrhodon, or Rosa including Banksianae, Bracteatae, Caninae, Carolinae, Chinesis, Gallicanae, Gymnocarpae, Laevigatae, Pimpinellifoliae Cinnamomeae, or Synstylae), butterfly bush (e.g., the plant species or cultivar is Asclepias tuberosa), Angelonia (e.g., a plant species or cultivar from the genus Angelonia), tomato plant (e.g., a species or cultivar of of Solanum lycopersicum), peppers (e.g., a species or cultivar from the Piperaceae family, a species or cultivar from the Capsicum genus), apple (e.g., a species or cultivar from Malus domestica), or Dahlia (e.g., a species or cultivar from the genus Dahlia such as Dahlia pinnata). In some embodiments, the first plant species or cultivar and second plant species or cultivar are different species. In certain aspects, the first plant species or cultivar and second plant species or cultivar are different species from the same genus. In various embodiments, the first plant species or cultivar and second plant species or cultivar are different species from the same family.

The success or failure of grafting of a combination of specific plant tissues depends on the environment, graft site, and treatment. Accordingly, grafting is possible by selecting an environment, graft site, and treatment suitable for plant tissues intended to be grafted. Grafting can be thereby completed between various plant tissues. In consideration of such a background, mediating properties for a wide range of plants (ferns, gymnosperms, and angiosperms that are classified as vascular plants)

In some embodiments, the graft utilizes a graft medium. The graft medium may include one or more plant tissues that may be inserted between the rootstalk and the scion. These graft mediums may increase the graft compatibility of the grafted plant. The graft medium may belong to the family Solanaceae, Brassicaceae, Lamiaceae, or Orobanchaceae. In some embodiments, the scion is from the family Solanaceae, Brassicaceae, Lamiaceae, or Orobanchaceae. In some embodiments, the rootstalk is from the family Solanaceae, Brassicaceae, Lamiaceae, or Orobanchaceae. In some embodiments, the graft medium and/or rootstalk and/or scion comprise a plant tissue of a plant belonging to the genus Nicotiana.

Examples of the form of the graft medium include a section (plant tissue) of a plant body having surfaces for grafting at both ends (root side and aerial tip side), and a plant body having surfaces for grafting in any two places (root side and aerial tip side). Examples of the surfaces for grafting include cut surfaces in various known forms that allow excellent contact, as necessary, such as flat, concave (e.g., V-shaped), and convex (e.g., projected) surfaces.

Specific examples of the form of the graft medium include a stem, petiole, etc. (of a seedling, for example) having surfaces for grafting at both ends, a plant body having surfaces for grafting in any two places of a stem, petiole, etc. (of a seedling, for example). The graft medium of the present disclosure may comprise tissues that undergo active cell activities, such as cell division, for example, parenchyma containing procambium. In particular embodiments, the graft medium includes tissues that undergo parenchyma. Examples of tissues which undergo parenchyma include cortex and pith of stems and roots, palisade tissue and spongy tissue of leaves, xylem parenchyma and phloem parenchyma of vascular bundles, pulp of fruit, tuber and root tuber, and other storage tissues.

The graft medium can be interposed between tissues of two plants belonging to different families (different-family plant tissues) to mediate these plant tissues, thereby completing grafting therebetween. Moreover, the graft medium can also complete grafting not only between different-family plants, but also between different-order plants.

Plants suitable for the scion, rootstalk, or grant medium may include ferns, gymnosperms, angiosperms (magnolias, monocots, and eudicots (eurosids I, eurosids II, euasterids I, euasterids II, and their outgroups)). Specific examples of the plants that are grafted through the graft medium/rootstalk/scion include plants belonging to the family Malvaceae, Brassicaceae, Asteraceae, Salicaceae, Ranunculaceae, Lauraceae, Chloranthaceae, Saururaceae, Araceae, Lamiaceae, Violaceae, Umbelliferae, Buxaceae, Ericaceae, Polygonaceae, Amaranthaceae, Convolvulaceae, Rosaceae, Santalaceae, Capparidaceae, Geraniaceae, Vitaceae, Fagaceae, Caprifoliaceae, Dipsacaceae, Fabaceae, Rutaceae, Sapindaceae, Proteaceae, Saxifragaceae, Apocynaceae, Gentianaceae, Aspidiaceae, Cupressaceae, Cucurbitaceae, Solanaceae, Pedaliaceae, Plantaginaceae, Orobanchaceae, Linderniaceae, Capparaceae, Calyceraceae, Goodeniaceae, Menyanthaceae, Stylidiaceae, Polygalaceae, Surianaceae, Muntingiaceae, Cytinaceae, Dipterocarpaceae, Sarcolaenaceae, Cistaceae, Bixaceae, Sphaerosepalaceae, Tetramelaceae, Begoniaceae, Datiscaceae, Berberidaceae, Menispermaceae, Byblidaceae, Stilbaceae, Scrophulariaceae, Mazaceae, Phrymaceae, Paulowniaceae, Piperaceae, Didymellaceae, Hypodematiaceae, Lomariopsis, Nephrolepidaceae, Tectariaceae, Oleandraceae, Polypodiaceae, Davalliaceae, Hypodematiaceae, Lomariopsis, Nephrolepidaceae, Tectariaceae, Oleandraceae, Polypodiaceae, Davalliaceae, and the like. Examples of animal repellent species, or species having animal repellent properties may be found in these families.

The rootstalk/scion/graft medium may be chosen from edible plants, including 620 species of 58 families of dicotyledons, 213 species of 20 families of monocotyledons, and 16 species of ferns.

Among the edible plants mentioned above, examples of dicotyledons include 68 species of legumes, such as soybeans, azuki beans, peas, and black-eyed peas; 57 species of cucurbits, such as cucumber, melon, watermelon, and pumpkin; 63 species of solanaceous plants, such as tobacco, eggplant, tomato, and green pepper; 57 species of Asteraceae plants, such as crown daisy, Japanese butterbur, burdock, and lettuce; 24 species of umbellifers, such as carrot, parsley, honewort, and celery; 23 species of Polygonaceae plants, such as sorrel, knotweed, rhubarb, and buckwheat; and 44 species of Amaranthaceae plants, such as spinach, saltwort, Swiss chard, and beet.

Further, among the edible plants mentioned above, examples of monocotyledons include 50 species of Liliaceae plants, 22 species of Araceae plants, 26 species of Dioscorea plants, and 40 species of Poaceae plants. Other examples include arboreous plants, such as Rutaceae and Palmae, and 149 species of 31 families of spices.

Solanaceae plants useful as the rootstalk, scion, or graft medium are not particularly limited. Examples include plants belonging to the genus Nicotiana, Anthocercis, Anthotroche, Crenidium, Cyphanthera, Duboisia, Grammosolen, Symonanthus, Petunia, Benthamiella, Bouchetia, Brunfelsia, Combera, Fabiana, Hunzikeria, Leptoglossis, Nierembergia, Pantacantha, Calibrachoa, Plowmania, Capsicum, Lycianthes, Solanum, Jaltomata, Datura, Brugmansia, Physalis, Physaliastrum, Tubocapsicum, Scopolia, Hyoscyamus, Atropa, Mandragora, Lycium, Calibrachoa, and the like. Among these, in terms of being capable of more efficiently completing grafting between different-family plants when used as a graft medium, preferable are Nicotiana, Anthocercis, Anthotroche, Crenidium, Cyphanthera, Duboisia, Grammosolen, Symonanthus, Petunia, Benthamiella, Bouchetia, Brunfelsia, Combera, Fabiana, Hunzikeria, Leptoglossis, Nierembergia, Pantacantha, Calibrachoa, Plowmania, Capsicum, Lycianthes, Solanum, Jaltomata, etc.; more preferable are Nicotiana, Petunia, Capsicum, Solanum, etc.; and even more preferable is Nicotiana.

Plants belonging to the genus Nicotiana are not particularly limited for use as the rootstalk, scion, or graft medium. Examples include Nicotiana benthamiana, Nicotiana tabacum, Nicotiana umbratica, Nicotiana rustica, Nicotiana acuminata, Nicotiana alata, Nicotiana attenuata, Nicotiana clevelandii, Nicotiana excelsior, Nicotiana forgetiana, Nicotiana glauca, Nicotiana glutinosa, Nicotiana langsdorffii, Nicotiana longiflora, Nicotiana obtusifolia, Nicotiana paniculata, Nicotiana plumbagifolia, Nicotiana quadrivalvis, Nicotiana repanda, Nicotiana suaveolens, Nicotiana sylvestris, Nicotiana tomentosa, and the like. Among these, in terms of being capable of more efficiently completing grafting between different-family plants when used as a graft medium, preferable are Nicotiana benthamiana, Nicotiana tabacum, Nicotiana umbratica, Nicotiana rustica, etc.; and more preferable is Nicotiana benthamiana.

Plants belonging to the genus Petunia (e.g., Petunia x hybrida) are not particularly limited for use of the rootstalk, scion, or graft medium. Examples include Petunia x atkinsiana (Petunia), Petunia alpicola, Petunia axillaris, Petunia bajeensis, Petunia bonjardinensis, Petunia exserta, Petunia guarapuavensis, Petunia inflata, Petunia integrifolia, Petunia interior, Petunia ledifolia, Petunia littoralis, Petunia mantiqueirensis, Petunia occidentalis, Petunia patagonica, Petunia reitzii, Petunia riograndensis, Petunia saxicola, Petunia scheideana, Petunia villadiana, and the like. Among these, in terms of being capable of more efficiently completing grafting between different-family plants when used as a graft medium, preferable is Petunia x atkinsiana.

Plants belonging to the genus Capsicum are not particularly limited for use as the rootstalk, scion, or graft medium. Examples include Capsicum annuum L. (e.g., “Grossum” (green pepper), “Abbreviatum,” “Acuminoum,” “Cerasiforme,” “Conoides,” “Fasciculatum,” “Longum,” “Nigrym,” “Parvo-acuminatum,” etc.), Capsicum baccatum, Capsicum cardenasii, Capsicum chinense Jacq. Heser & Smith, Capsicum frutescens L., Capsicum pubescens Ruiz & Pay., and the like. Among these, in terms of being capable of more efficiently completing grafting between different-family plants when used as a graft medium, preferable is Capsicum annuum L., and more preferable is Capsicum annuum L. “Grossum” (green pepper).

Plants belonging to the genus Solanum are not particularly limited for use as the rootstalk, scion, or graft medium. Examples include Solanum lycopersicum L. (tomato), Solanum melongena L. (eggplant), Solanum tuberosum L., Solanum acaule Bitt., Solanum aethiopicum L., Solanum betaceum Cav., Solanum jasminoides Paxt., Solanum mammosum L., Solanum muricatum Aiton, Solanum nigrum L., Solanum pseudocapsicum L., Solanum ptychanthum Dunal, and the like. Among these, in terms of being capable of more efficiently completing grafting between different-family plants when used as a graft medium, preferable are Solanum lycopersicum L. (tomato), Solanum melongena L. (eggplant), etc.

Brassicaceae plants are not particularly limited for use as the rootstalk, scion, or graft medium. Examples include plants belonging to the genus Arabidopsis, Brassica, Capsella, Cardamine, Aethionema, Camelina, Armoracia, Barbarea, Nasturtium, Rorippa, Lepidium, Coronopus, Descurainia, Alyssum, Aurinia, Lobularia, Sisymbrium, Diplotaxis, Eruca, Raphanus, Hirschfeldia, Sinapis, Rapistrum, Orychophragmus, Isatis, Eutrema, Thlaspi, Arabis, Aubrieta, Draba, Macropodium, Noccaea, Iberis, Cochlearia, Malcolmia, Matthiola, Hesperis, Chorispora, Lunaria, and the like. Among these, in terms of being capable of more efficiently completing grafting between different-family plants when used as a graft medium, preferable are Arabidopsis, Camelina, Brassica, Diplotaxis, Eruca, Raphanus, Hirschfeldia, Sinapis, Rapistrum, Orychophragmus, Capsella, Cardamine, Armoracia, Barbarea, Nasturtium, Rorippa, etc.; more preferable are Arabidopsis, Brassica, Capsella, Cardamine, etc.; even more preferable are Arabidopsis, Brassica, etc.; and still more preferable is Arabidopsis.

Plants belonging to the genus Arabidopsis are not particularly limited for use as the rootstalk, scion, or graft medium. Examples include Arabidopsis thaliana, Arabidopsis arenicola, Arabidopsis arenosa, Arabidopsis cebennensis, Arabidopsis croatica, Arabidopsis halleri, Arabidopsis lyrata, Arabidopsis neglecta, Arabidopsis pedemontana, Arabidopsis suecica, and the like. Among these, in terms of being capable of more efficiently completing grafting between different-family plants when used as a graft medium, preferable is Arabidopsis thaliana.

Plants belonging to the genus Brassica are not particularly limited for use as the rootstalk, scion, or graft medium. Examples include Brassica oleracea (e.g., broccoli, cauliflower, cabbage, etc.), Brassica napus (e.g., coleseed etc.), Brassica barrelieri, Brassica carinata, Brassica elongata, Brassica fruticulosa, Brassica juncea, Brassica narinosa, Brassica nigra, Brassica nipposinica, Brassica rapa, Brassica rupestris, Brassica tournefortii, and the like. Among these, in terms of being capable of more efficiently completing grafting between different-family plants when used as a graft medium, preferable are Brassica oleracea, Brassica napus, etc.; more preferable is Brassica oleracea; and even more preferable is broccoli.

Plants belonging to the genus Capsella are not particularly limited for use as the rootstalk, scion, or graft medium. Examples include Capsella rubella, Capsella abscissa, Capsella andreana, Capsella australis, Capsella austriaca, Capsella bursa-pastoris, Capsella divaricata, Capsella draboides, Capsella gracilis, Capsella grandiflora, Capsella humistrata, Capsella hybrida, Capsella hyrcana, Capsella integrifolia, Capsella lycia, Capsella mexicana, Capsella orientalis, Capsella pillosula, Capsella pubens, Capsella puberula, Capsella schaffneri, Capsella stellata, Capsella tasmanica, Capsella thomsoni, Capsella thracica, Capsella viguieri, Capsella villosula, and the like. Among these, in terms of being capable of more efficiently completing grafting between different-family plants when used as a graft medium, preferable is Capsella rubella.

Plants belonging to the genus Cardamine are not particularly limited for use as the rootstalk, scion, or graft medium. Examples Cardamine hirsuta, Cardamine anemonoides, Cardamine appendiculata, Cardamine arakiana, Cardamine dentipetala, Cardamine dentipetala var. longifructa, Cardamine fallax, Cardamine impatiens, Cardamine kiusiana, Cardamine leucantha, Cardamine lyrata, Cardamine niigatensis, Cardamine nipponica, Cardamine pratensis, Cardamine regeliana, Cardamine schinziana, Cardamine scutata, Cardamine tanakae, Cardamine torrentis, Cardamine valida, and the like. Among these, in terms of being capable of more efficiently completing grafting between different-family plants when used as a graft medium, preferable is Cardamine hirsuta.

Lamiaceae plants are not particularly limited for use as the rootstalk, scion, or graft medium. Examples include plants belonging to the genus Perilla, Lavandula, Callicarpa, Vitex, Tectona, Premna, Ajuga, Clerodendrum, Caryopteris, Amethystea, Teucrium, Keiskea, Elsholtzia, Mosla, Agastache, Nepeta, Origanum, Mentha, Dracocephalum, Glechoma, Hyssopus, Prunella, Lycopus, Meehania, Melissa, Monarda, Salvia, Satureja, Rosmarinus, Thymus, Clinopodium, Isodon, Hyptis, Ocimum, Scutellaria, Stachys, Suzukia, Lamium, Galeopsis, Chelonopsis, Pogostemon, Leucosceptrum, Leonurus, Loxocalyx, Leucas, Marrubium, and the like. Among these, in terms of being capable of more efficiently completing grafting between different-family plants when used as a graft medium, preferable are Perilla, Lavandula, Keiskea, Elsholtzia, Mosla, Agastache, Nepeta, Origanum, Mentha, Dracocephalum, Glechoma, Hyssopus, Prunella, Lycopus, Meehania, Melissa, Monarda, Salvia, Satureja, Rosmarinus, Thymus, Clinopodium, Isodon, Hyptis, Ocimum, etc.; more preferable are Perilla, Lavandula, etc.; and even more preferable is Perilla.

Plants belonging to the genus Perilla are not particularly limited for use as the rootstalk, scion, or graft medium. Examples include Perilla frutescens (e.g., shiso, sesame, etc.). Among these, in terms of being capable of more efficiently completing grafting between different-family plants when used as a graft medium, preferable is Perilla frutescens; and more preferable is shiso.

Plants belonging to the genus Lavandula are not particularly limited for use as the rootstalk, scion, or graft medium. Examples include Lavandula angustifolia (lavender), Lavandula latifolia, Lavandula stoechas, Lavandula multifida, Lavandulax intermedia, and the like. Among these, in terms of being capable of more efficiently completing grafting between different-family plants when used as a graft medium, preferable is Lavandula angustifolia (lavender).

Orobanchaceae plants are not particularly limited for use as the rootstalk, scion, or graft medium. Examples include plants belonging to the genus Phtheirospermum, Castilleja, Orthocarpus, Agalinis, Aureolaria, Esterhazya, Seymeria, Lamourouxia, Cordylanthus, Triphysaria, Aeginetia, Boschniakia, Cistanche, Orobanche, Phacellanthus, Euphrasia, Lathraea, Melampyrum, Monochasma, Parentucellia, Pedicularis, Siphonostegia, Striga, and the like. Among these, in terms of being capable of more efficiently completing grafting between different-family plants when used as a graft medium, preferable are Phtheirospermum, Pedicularis, Castilleja, Orthocarpus, Agalinis, Aureolaria, Esterhazya, Seymeria, Lamourouxia, Cordylanthus, Triphysaria, etc.; and more preferable is Phtheirospermum.

Plants belonging to the genus Phtheirospenum are not particularly limited for use as the rootstalk, scion, or graft medium. Examples include Phtheirospermum japonicum, Phtheirospermum glandulosum, Phtheirospermum muliense, Phtheirospermum parishii, Phtheirospermum tenuisectum, and the like. Among these, in terms of being capable of more efficiently completing grafting between different-family plants when used as a graft medium, preferable is Phtheirospermum japonicum.

Generally, the graft medium can help facilitate formation of the graft union.

When a plant tissue of Solanaceae, such as Petunia, Capsicum, or Solanum, may be used as the graft medium, preferable examples of the plants grafted, optionally through the graft medium, include plants belonging to the Brassicaceae, Cleomaceae, Capparaceae, Asteraceae, Calyceraceae, Goodeniaceae, Menyanthaceae, Stylidiaceae, Apocynaceae, Gentianaceae, Fabaceae, Polygalaceae, Surianaceae, and the like; and more preferably Brassicaceae, Asteraceae, Apocynaceae, Fabaceae, and the like.

When a plant tissue of Brassicaceae, such as Arabidopsis, is used as the graft medium, preferable examples of the plants grafted through the graft medium include plants belonging to Asteraceae, Calyceraceae, Goodeniaceae, Menyanthaceae, Stylidiaceae, Malvaceae, Muntingiaceae, Cytinaceae, Dipterocarpaceae, Sarcolaenaceae, Cistaceae, Bixaceae, Sphaerosepalaceae, Cucurbitaceae, Tetramelaceae, Begoniaceae, Datiscaceae, Ranunculaceae, Berberidaceae, Menispermaceae, Linderniaceae, Byblidaceae, Stilbaceae, Plantaginaceae, Scrophulariaceae, Lamiaceae, Mazaceae, Phrymaceae, Paulowniaceae, Solanaceae, Convolvulaceae, Fabaceae, Polygalaceae, Surianaceae, Apocynaceae, Gentianaceae, Orobanchaceae, and the like; and more preferably Asteraceae, Malvaceae, Cucurbitaceae, Ranunculaceae, Linderniaceae, Plantaginaceae, Lamiaceae, Solanaceae, Convolvulaceae, Fabaceae, Apocynaceae, and Orobanchaceae.

When a plant tissue of Lamiaceae, such as Perilla, is used as the graft medium, preferable examples of the plants grafted through the graft medium include Brassicaceae, Cleomaceae, Capparaceae, Fabaceae, Polygalaceae, Surianaceae, Asteraceae, Calyceraceae, Goodeniaceae, Menyanthaceae, Stylidiaceae, Cucurbitaceae, Tetramelaceae, Begoniaceae, Datiscaceae, Solanaceae, Convolvulaceae, Saururaceae, Piperaceae, Apocynaceae, Gentianaceae, Buxaceae, Didymellaceae, Orobanchaceae, Mazaceae, Phrymaceae, Paulowniaceae, and the like; and more preferably Brassicaceae, Fabaceae, Asteraceae, Cucurbitaceae, Solanaceae, Saururaceae, Apocynaceae, Buxaceae, Orobanchaceae, and the like.

When a plant tissue of Orobanchaceae, such as Phtheirospermum, is used as the graft medium, preferable examples of the plants grafted through the graft medium include Apocynaceae, Gentianaceae, Asteraceae, Calyceraceae, Goodeniaceae, Menyanthaceae, Stylidiaceae, Fabaceae, Polygalaceae, Surianaceae, Buxaceae, Didymellaceae, Saururaceae, Piperaceae, Aspidiaceae, Hypodematiaceae, Lomariopsis, Nephrolepidaceae, Tectariaceae, Oleandraceae, Polypodiaceae, Davalliaceae, Cucurbitaceae, Tetramelaceae, Begoniaceae, Datiscaceae, Solanaceae, Convolvulaceae, Brassicaceae, Cleomaceae, Capparaceae, and the like; and more preferably Apocynaceae, Asteraceae, Fabaceae, Buxaceae, Saururaceae, Dryopteridaceae, Cucurbitaceae, Solanaceae, Brassicaceae, and the like.

The present disclosure relates to a plant tissue comprising two different-family plant tissues optionally grafted through a graft medium, wherein one of the different family plants comprises animal repellent properties. In some embodiments, the rootstalk and/or scion are cultivar. Specific examples of cultivar include solanums, such as tomato, green pepper, red pepper, and eggplant; cucurbits, such as cucumber, pumpkin, melon, and watermelon; leafy vegetables, such as cabbage, broccoli, and Chinese cabbage; green vegetables and condiment vegetables, such as celery, parsley, and lettuce; alliums, such as Welsh onion, onion, and garlic; legumes, such as soybeans, peanuts, kidney beans, peas, and azuki beans; other fruit vegetables, such as strawberry; axial roots, such as radish, turnip, carrot, and burdock; potatoes, such as taro, cassava, Irish potato, sweet potato, and yam; potherbs, such as asparagus, spinach, and honewort; flowering plants, such as prairie gentian, stock, carnation, and chrysanthemum; grains, such as rice and corn; grasses, such as bentgrass and Zoysia matrella; oil crops, such as rapeseed and peanut; sugar crops, such as sugar cane and sugar beet; fiber crops, such as cotton and rush; forage crops, such as clover, sorghum, and dent corn; deciduous fruit trees, such as apple, pear, grape, and peach; citrus, such as Satsuma orange, lemon, and grapefruit; arbor, such as satsuki, azalea, and cedar; and the like.

In various impementations, the first plant species or cultivar is rootstalk. In some embodiments, the first plant species or cultivar is a scion. In some embodiments, the second plant species or cultivar is rootstalk. In certain aspects, the second plant species or cultivar is a scion.

Methods of forming a grafted plant body are also provided comprising joining the tissue from a first plant species or cultivar with a second plant species or cultivar, wherein the second plant species or cultivar comprises animal repellent properties and the grafted plant body comprises a flower or fruit from the first plant species or cultivar. For example, the method may comprise:
a) exposing the tissue of the first plant species or cultivar (e.g., via cutting);
b) exposing the tissue of the second plant species or cultivar (e.g., via cutting);
c) contacting the exposed tissues from the first and second plant species or cultivars for a time period and under conditions sufficient to join the tissue.
   In certain aspects, the method may comprise:
a) exposing the tissue of the first plant species or cultivar (e.g., via cutting);
b) exposing the tissue of the second plant species or cultivar (e.g., via cutting);
c) contacting the exposed tissues from the first plant species or cultivar to a graft medium; and
d) contacting the exposed tissues from the second plant species or cultivar to the graft medium;
   wherein steps c) and d) occur for a time period and under conditions sufficient to join the tissue.

The contacting step can be carried out using a known grafting method. For example, this step may be carried out using the graft medium or the first plant tissue as an interstock, the second plant tissue as a stock, and the third plant tissue as a scion. Further, graft surfaces are closely attached to each other, as appropriate, after connecting treatment, and the connected portion can be suitably supported with a film, an instrument, or the like, as required, so that a closely attached state can be physically formed.

The order of connecting the plant tissues is not particularly specified. All of the plant tissues may be connected at the same period and grown (cultured). Alternatively, the second plant tissue and the graft medium may be grown (cultured) in a grafted state, and then the third plant tissue may be added and connected to obtain a connected body. Alternatively, the graft medium and the third plant tissue may be grown (cultured) in a grafted state, and then the second plant tissue may be added and connected to obtain a grafted plant body. Alternatively, a grafted body of the second plant tissue and the graft medium, and a grafted body of the third plant tissue and the graft medium may be separately prepared, and the graft media in these grafted bodies may be grafted with each other.

The rootstocks/scions/graft medium to be grafted may be mechanically joined by methods such as wrapping with rubber or plastic grafting strips, string, and the like. The graft area is placed in an opening such that the graft union area is substantially encompassed by the opening. Warm air may be in contact with the graft unions placed in the openings. The unions may be heated at a temperature, known to promote rapid callusing for a period until the callus bridge between the rootstock and scion (or graft medium) is formed. In general, the temperature may be in a range of 15° C. to 35° C. (e.g., 21° to 27° C.).

As various changes can be made in the above-described subject matter without departing from the scope and spirit of the present disclosure, it is intended that all subject matter contained in the above description, or defined in the appended claims, be interpreted as descriptive and illustrative of the present disclosure. Many modifications and variations of the present disclosure are possible in light of the above teachings. Accordingly, the present description is intended to embrace all such alternatives, modifications and variances which fall within the scope of the appended claims.

All documents cited or referenced herein and all documents cited or referenced in the herein cited documents, together with any manufacturer's instructions, descriptions, product specifications, and product sheets for any products mentioned herein or in any document incorporated by reference herein, are hereby incorporated by reference, and may be employed in the practice of the disclosure.

1. A grafted plant body between a rootstalk and a scion, wherein the rootstalk or scion comprises a flower, fruit, or vegetable from a first plant species or cultivar, and the other of the rootstalk or scion comprises an animal (e.g., deer, nematode, insect such as mosquito) resistant portion of a second plant species or cultivar.

2. The grafted plant body according to claim 1, wherein the animal resistant portion is a deer resistant portion.

3. The grafted plant body according to claim 1, wherein the rootstalk is directly grafted to the scion.

4. The grafted plant body according to claim 1, wherein the rootstalk is grafted to the scion via one or more graft mediums.

5. The grafted plant body according to claim 1, wherein the scion comprises an animal resistant portion of a second plant species or cultivar.

6. The grafted plant body according to claim 1, wherein the animal resistant portion of the second plant species or cultivar is the flowers or foliage of the second plant species or cultivar.

7. The grafted plant body according to claim 1, wherein the second plant species or cultivar is Zinnia (e.g. the plant species or cultivar is from the genus Zinnia), rosemary (e.g., the plant species or cultivar is Salvia rosmarinus), marigold (e.g., the plant species or cultivar is from the genus Tagetes such as Tagetes patula, Tagetes lucida, or Tagetes minuta), fountain grass (e.g., the plant species or cultivar is from the genus Pennisettum including Pennisetum typhoideum, Pennisetum villosum, Penisettum candestinum, Pennisettum advena, Pennisettum alopecuroides, Pennisettum orentale, or Pennisetum setaceum) spider flower (e.g., the plant species or cultivar is from the genus Cleome such as Cleome hassleriana, the plant species is from the genus Grevillea such as Grevillea albiflora, Grevillea buxifolia, Grevillea mucronulata, Grevillea oleoides, Grevillea sericea, Grevillea speciosa), carolina jessamine (e.g., the plant species or cultivar is Gelsemium sempevirens), Wisteria (e.g., the plant species or cultivar is from the genus Wisteria such as Wisteria sinensis or Wisteria floribunda), Verbena (e.g., the plant species or cultivar is from the genus Verbena such as Verbena bonariensis, Verbena officinalis), bee balm (e.g., the plant species or cultivar is from the genus Monarda such as Monarda didyma or Monarda panorama), daffodil (e.g., the plant species or cultivar is from the genus Narcissus such as Narcissus poeticus), lavender (e.g., the plant species or cultivar is from the genus Lavandula such as Lavandula spica), wax Begonia (the plant cultivar is Begonia x semperflorens-cultorum), lamb's ear (the plant species or cultivar is Stachys byzantine (syn. lanata or olympica)), Vinca (the plant is from the genus Vinca such as Vinca difformis), star jasmine (the plant species or cultivar is Trachelospermum jasminoides), Allium (the plant species or cultivar is from the genus Allium such as Allium sativum, Allium flavum, Allium carinatum, Allium schoenoprasum, or Allium oreophilum), foxglove (e.g., the plant species or cultivar is from the genus Digitalis such as Digitalis purpurea, Digitalis ferruginea, Digitalis grandiflora, Digitalis lutea, Digitalis parviflora), Coleus (e.g., the plant species or cultivar or cultivar is from the genus Coleus such as Coleus amboinicus or Coleus scutellariodes), purple heart (e.g., the plant species or cultivar is Tradescantia pallida), butterfly bush/weed (e.g., the plant species or cultivar is Asclepias tuberosa), Coreopsis (e.g., the plant species or cultivar is from the genus Coreopsis such as Coreopsis gigantea), Cosmos (the plant species or cultivar is from the genus Cosmos such as Cosmos bipinnatus, or Cosmos sulphureus), autumn fern (e.g., the plant species or cultivar is Dryopteris erythrosora), coneflower (e.g., the plant species or cultivar is from the genus Dracopis, Echinacea, Rudbeckia, Ratibida, or Isopogon), flossflower (e.g., the plant species or cultivar is \Ageratum houstonianum), signet marigold (e.g., the plant species or cultivar is Tagetes tenuifolia), snapdragon (e.g., the plant species or cultivar is from the genus Antirrhinum such as Antirrhinum majus or Antirrhinum mole), boxwood (e.g., the plant species or cultivar is from the genus Buxus such as Buxus sempervirens or Buxus sinica), cinquefoil (e.g., the plant species or cultivar is from the genus Potentilla such as Potentilla reptans), butterfly bush (e.g., the plant species or cultivar is from the genus Buddleja such as Buddleja davidii or Buddleja globose or from the genus Rotheca such as Rotheca myricoides), Spirea (e.g., the plant species or cultivar is from the genus Spiraea such as Spiraea salicifolia), juniper (e.g., the plant species or cultivar is from the genus Juniperus such as Junperus osteosperma or Juniperus communis, russian sage (e.g., the plant species or cultivar is Salvia yangii), fringed bleeding heart (e.g., the plant species or cultivar is Dicentra eximia), monkshood (e.g., the plant species or cultivar is from the genus Acontium such as Aconitum variegatum), peony (e.g., the plant species or cultivar is from the genus Paeonia such as Paeonia suffruticosa or Paeonia officinalis), black cohosh (e.g., the plant species or cultivar is Actaea racemosa), dusty miller (e.g., the plant species or cultivar is Centaurea cineraria), lamb's ear (e.g., the plant species or cultivar is Stachys byzantina), Japanese Pachysandra (e.g., the plant species or cultivar is Pachysandra terminalis), Japanese painted fern (e.g., Athyrium niponicum), lady's mantle (e.g., the plant species or cultivar is from the genus Alchemilla such as Alchemilla mollis), lily of the valley (e.g., the plant species or cultivar is Convallaria majalis), or Japanese sedge (e.g., the plant species or cultivar is Carex morrowii).

8. The grafted plant body according to claim 1, wherein the first plant species or cultivar and/or the second plant species or cultivar are selected from lavender lavender (e.g., the plant species or cultivar is from the genus Lavandula such as Lavandula spica), dusty miller (e.g., the plant species or cultivar is Centaurea cineraria), Agastache (e.g., the plant species or cultivar is from the genus Agastache such as Agastache cusickii, Agastache foeniculum, Agastache (Pursh) Kuntze, Agastache nepetoides, Agastache occidentalis, Agastache parvifolia, Agastache rugosa, Agastache scrophulariifolia, or Agastache urticifola), Hydrangea (e.g., the plant species or cultivar is from the genus Hydrangea such as Hydrangea macrophylla, Hydrangea anomala, Hydrangea arborescens, Hydrangea aspera, Hydrangea bretschneideri, Hydrangea chinensis, Hydrangea chungii, Hydrangea cinerea, Hydrangea coenobialis, Hydrangea davidii, Hydrangea glaucescens, Hydrangea gracilis, Hydrangea heteromalla, Hydrangea hirta, Hydrangea hydrangeoides, Hydrangea hypoclauca, Hydrangea integrifolia, Hydrangea involucrata, Hydrangea jelskii, Hydrangea kwangsiensis, Hydrangea kwangtungensis, Hydrangea longifolia, Hydrangea longipes, Hydrangea macrocarpa, Hydrangea macrophylla, Hydrangea mangshanensis, Hydrangea paniculata, Hydrangea peruviana, Hydrangea petiolaris, Hydrangea quercifolia, Hydrangea radiata, Hydrangea robusta, Hydrangea sargentiana, Hydrangea scandens, Hydrangea serrata, Hydrangea serratifolia, Hydrangea strigosa, Hydrangea stylosa, Hydrangea tarapotensis, Hydrangea xanthoneura, or Hydrangea zhewanensis), Sage (e.g., a plant or cultivar from the Salvia such as Salvia officinalis or the genus Leucophyllum or the genus Artemisia), rosemary (e.g., the plant species or cultivar is Salvia rosmarinus), rose (e.g., a genus or cultivar from the genus Rosa such as Rosa rubiginosa, Rosa ‘precious platinum’, Rosa hemisphaerica, a plant or cultivar from the subgenus Hulthemia, Hesperrhodos, Platyrhodon, or Rosa including Banksianae, Bracteatae, Caninae, Carolinae, Chinesis, Gallicanae, Gymnocarpae, Laevigatae, Pimpinellifoliae Cinnamomeae, or Synstylae), butterfly bush (e.g., the plant species or cultivar is Asclepias tuberosa), Angelonia (e.g., a plant species or cultivar from the genus Angelonia), tomato plant (e.g., a species or cultivar of of Solanum lycopersicum), peppers (e.g., a species or cultivar from the Piperaceae family, a species or cultivar from the Capsicum genus), apple (e.g., a species or cultivar from Malus domestica), or Dahlia (e.g., a species or cultivar from the genus Dahlia such as Dahlia pinnata).

9. The grafted plant body according to claim 1, wherein the first plant species or cultivar and the second plant species or cultivar are the same species.

10. The grafted plant body according to claim 1, wherein the first plant species or cultivar and second plant species or cultivar are different species.

11. The grafted plant body according to claim 1, wherein the first plant species or cultivar and second plant species or cultivar are different species from the same genus.

12. The grafted plant body according to claim 1, wherein the first plant species or cultivar and second plant species or cultivar are different species from the same family.

13. A method of forming a grafted plant body comprising joining the tissue from a first plant species or cultivar with a second plant species or cultivar, wherein the second plant species or cultivar comprises animal repellent properties and the grafted plant body comprises a flower or fruit from the first plant species or cultivar.

14. The method according to claim 13 comprising:
a) exposing the tissue of the first plant species or cultivar (e.g., via cutting);
b) exposing the tissue of the second plant species or cultivar (e.g., via cutting);
c) contacting the exposed tissues from the first and second plant species or cultivars for a time period and under conditions sufficient to join the tissue.

15. The method according to claim 13 comprising:
a) exposing the tissue of the first plant species or cultivar (e.g., via cutting);
b) exposing the tissue of the second plant species or cultivar (e.g., via cutting);
c) contacting the exposed tissues from the first plant species or cultivar to a graft medium; and
d) contacting the exposed tissues from the second plant species or cultivar to the graft medium;
wherein steps c) and d) occur for a time period and under conditions sufficient to join the tissue.

16. The method according to claim 13, wherein the first plant species or cultivar is rootstalk.

17. The method according to claim 13, wherein the first plant species or cultivar is a scion.

18. The method according to claim 13, wherein the second plant species or cultivar is rootstalk.

19. The method according to claim 13, wherein the second plant species or cultivar is a scion.
